(19) United States
(12) Patent Application Publication
(10) Pub. No.: US 2025/0192244 A1
(43) Pub. Date: Jun. 12, 2025

(54) TRACTION BATTERY PACK BUSBAR CONNECTION SYSTEM

(71) Applicant: Ford Global Technologies, LLC, Dearborn, MI (US)

(72) Inventors: Ryan Douglas Matulich, Farmington, MI (US); Karen Siler, Commerce Twp., MI (US); Jason C. Marcath, Dearborn, MI (US)

(21) Appl. No.: 18/802,483

(22) Filed: Aug. 13, 2024

Related U.S. Application Data
(60) Provisional application No. 63/607,888, filed on Dec. 8, 2023.

(51) Int. Cl. H01M 10/42; B60L 50/64; H01M 50/204; H01M 50/249; H01M 50/296; H01M 50/502

(52) U.S. Cl. CPC H01M 10/425; B60L 50/64; H01M 50/204; H01M 50/249; H01M 50/296; H01M 50/502; H01M 2220/20

(57) ABSTRACT

A traction battery pack system includes one or more busbars protruding from a battery array of a traction battery pack, and a control module assembly that slidably receives the one or more busbars to electrically couple the control module assembly to the one or more busbars. The control module assembly can be a bussed electrical center.

### CROSS-REFERENCE TO RELATED APPLICATIONS

This disclosure claims priority to U.S. Provisional Application No. 63/607,888, which was filed on Dec. 8, 2023, and is incorporated herein by reference in its entirety.

### TECHNICAL FIELD

This disclosure relates generally to electrically connecting a control module of a traction battery pack to one or more busbars.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a traction battery pack system, including: one or more busbars protruding from a battery array of a traction battery pack; and a control module assembly that slidably receives the one or more busbars to electrically couple the control module assembly to the one or more busbars.

In some aspects, the techniques described herein relate to a traction battery pack system, wherein the one or more busbars protrude vertically upward from the battery array.

In some aspects, the techniques described herein relate to a traction battery pack system, wherein the control module assembly is secured relative to the battery array at a position vertically above the battery array when the one or more busbars are received by the control module assembly.

In some aspects, the techniques described herein relate to a traction battery pack system, wherein the control module is configured to transition from an electrically decoupled position with the one or more busbars to an electrically decoupled position with the one or more busbars by moving the control module assembly in a single direction relative to the battery array.

In some aspects, the techniques described herein relate to a traction battery pack system, wherein the control module assembly includes one or more pockets, the one or more busbars each received within a respective pocket of the one or more pockets when the control module assembly is electrically coupled to the one or more busbars.

In some aspects, the techniques described herein relate to a traction battery pack system, further including at least one terminal tab disposed within the one or more pockets, the at least one terminal tab contacting the one or more busbars when the control module assembly is electrically coupled to the one or more busbars.

In some aspects, the techniques described herein relate to a traction battery pack system, wherein the control module assembly includes a bussed electrical center and a tray, the tray secured directly to the battery array.

In some aspects, the techniques described herein relate to a traction battery pack system, wherein the bussed electrical center is configured to manage the distribution of electrical power between the battery pack and the vehicle.

In some aspects, the techniques described herein relate to a traction battery pack system, wherein the one or more busbars are one or more first busbar, wherein the battery array is a first battery array, and further including at least one second battery array having one or more second busbars that protrude from the at least one second battery array, the control module assembly configured to slidably receive the one or more second busbars to electrically coupled the control module assembly to the one or more second busbars.

In some aspects, the techniques described herein relate to a traction battery pack system, wherein the one or more busbars each include a protruding portion that protrudes from the battery array and is received by the control module assembly when the control module assembly slidably receives the one or more busbars.

In some aspects, the techniques described herein relate to a battery module assembly of a traction battery pack, including: a control module of a traction battery pack, the control module configured to slide linearly relative to one or more busbars of a battery array from a first position where the control module is electrically decoupled from the battery array to a second position where the control module is electrically coupled to the one or more busbar of the battery array.

In some aspects, the techniques described herein relate to a battery module assembly, wherein the control module is a bussed electrical center.

In some aspects, the techniques described herein relate to a battery module assembly, wherein the control module moves vertically downward from the first position to the second position.

In some aspects, the techniques described herein relate to a battery module assembly, wherein the control module includes one or more pockets that each respectively receive a portion of the one or more busbars when the control module is electrically coupled to the battery array.

In some aspects, the techniques described herein relate to a traction battery pack electrical connection method, including: transitioning a control module along an axis from a first position to a second position relative to a battery array, the control module electrically decoupled from the battery array in the first position, the control module electrically coupled to the battery array in the second position; and during the transitioning, receiving portions of a plurality of busbars within respective pockets of the control module.

In some aspects, the techniques described herein relate to a method, wherein the busbars within the plurality of busbars extend vertically upward from the battery array.

In some aspects, the techniques described herein relate to a method, further including, when the portions of the plurality of busbars are received within the respective pockets, contacting the plurality of busbars against terminal tabs disposed within the respective pockets to electrically coupled the control module to the battery array.

In some aspects, the techniques described herein relate to a method, wherein the transitioning is a vertically downward transitioning of the control module.

In some aspects, the techniques described herein relate to a method, wherein the bussed electrical center is configured to manage a distribution of electrical power between the battery pack and the vehicle.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a close-up of an area of FIG. 2 showing busbars of the battery pack protruding vertically upward up from the battery array.

FIG. 4 illustrates a control module of the battery pack receiving busbars of the battery pack within respective pockets of the control module.

FIG. 5 illustrates a section view through a pocket of the control module prior to the pocket receiving one of the busbars of FIG. 3.

FIG. 6 illustrates a section view through the pocket of FIG. 5 after the pocket receives the one of the busbars of FIG. 3.

### DETAILED DESCRIPTION

This disclosure details exemplary systems and methods where a control module of a traction battery pack, such as a battery electric control module, can be electrically coupled to busbars of the traction battery pack by moving the control module linearly in a single direction. This approach can provide finger protection during assembly and can reduce a required number of assembly steps when compared to securing busbars to a control module utilizing mechanical fasteners that engage each busbar.

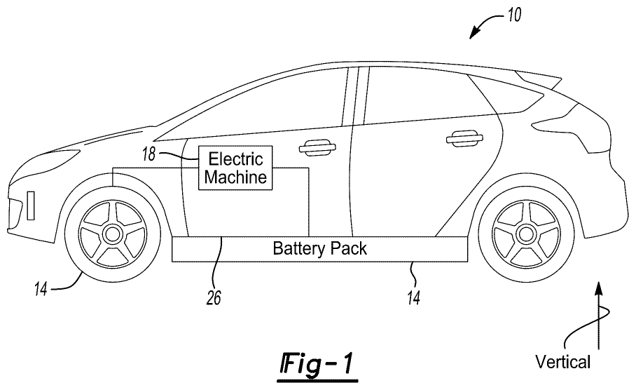

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

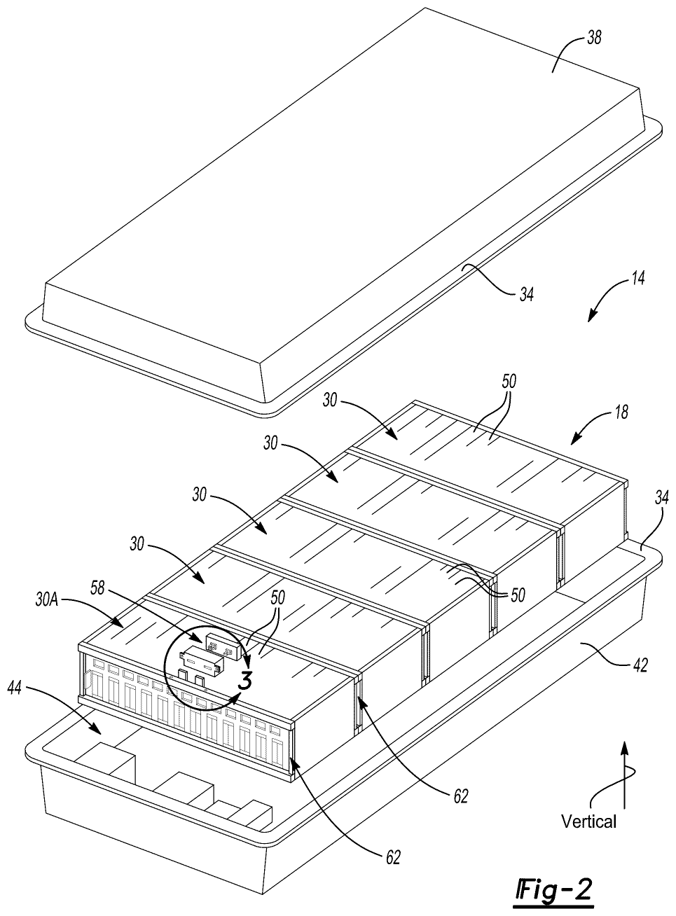

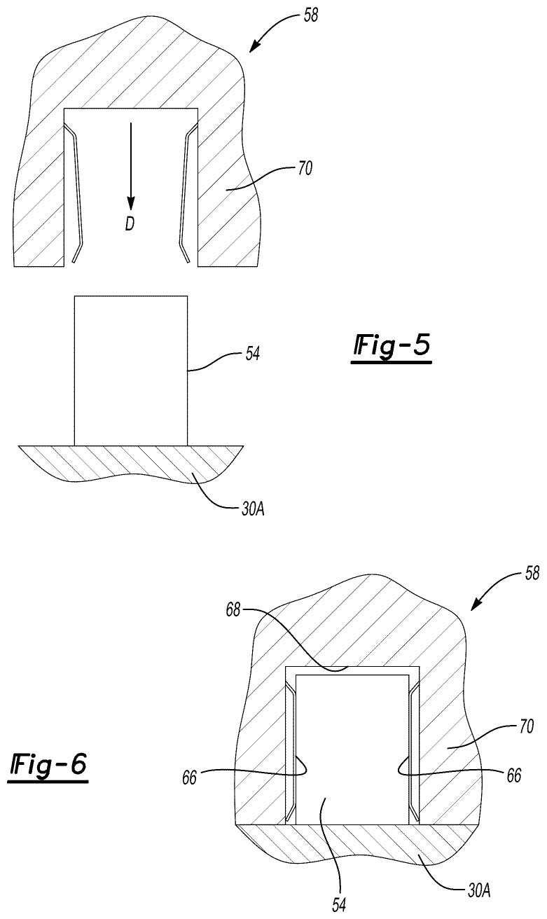

With reference now to FIGS. 2 to 6, the battery pack 14 includes a plurality of battery arrays 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the battery arrays 30. The enclosure cover 38 can be secured to the enclosure tray 42 using mechanical fasteners (not shown), for example.

Each of the battery arrays 30 includes, among other things, a plurality of battery cells 50 (or simply “cells”) stacked side-by-side relative to each along a respective battery array axis. The battery cells 50 store and supply electrical power. Although a specific number of the battery arrays 30 and cells 50 are illustrated in the various figures of this disclosure, the battery pack 14 could include any number of the battery arrays 30 each having any number of individual cells 50.

In an embodiment, the battery cells 50 are lithium-ion pouch-style cells. However, battery cells having other geometries (cylindrical, prismatic, etc.), other chemistries (nickel metal hydride, lead acid, etc.), or both could be alternatively utilized within the scope of this disclosure.

Extending upward from the battery array 30A are a plurality of busbars 54. In this example, portions of two busbars 54 protrude vertically upward from the array 30A. Vertical, for purposes of this disclosure, is with reference to ground and a general orientation of the battery pack when installed in the vehicle.

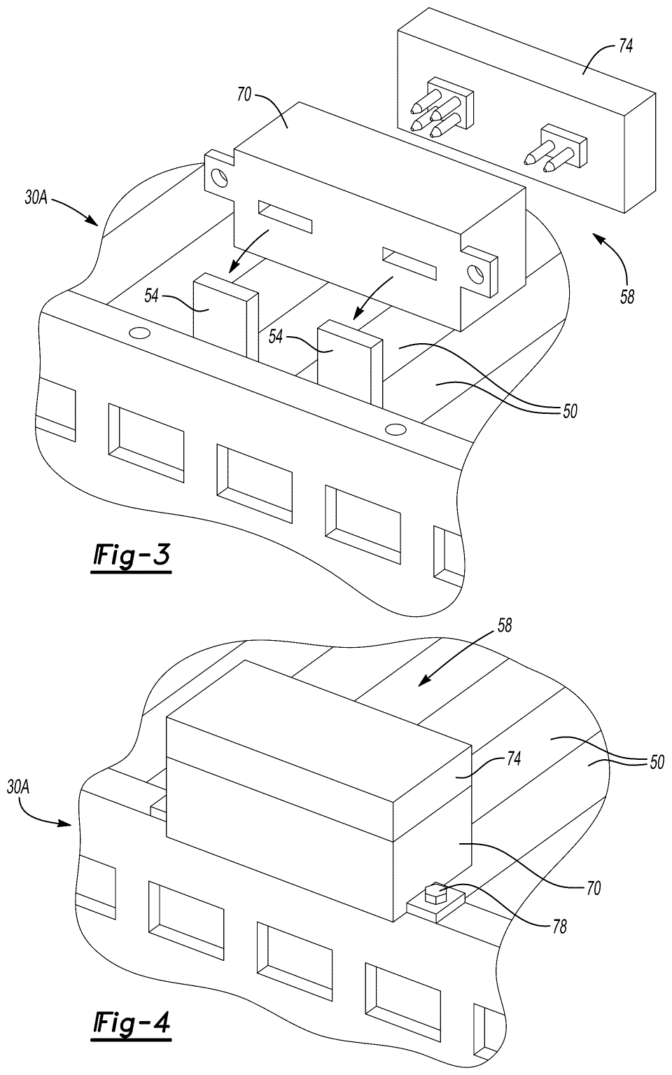

A control module assembly 58 can move vertically downward from a position where the control module is electrically decoupled from the busbars 54 as shown in FIGS. 2, 3, and 5 to a position where the control module assembly 58 is electrically coupled to the busbars 54 as shown in FIGS. 4 and 6. The control module assembly 58 is secured relative to the battery array 30A at a position that is vertically above the battery array 30A when the busbars 54 are received by the control module assembly 58.

Since the electronic coupling occurs by moving the control module assembly 58 vertically downward in a single direction D, an installer's hands are shielded from contact with the busbars 54 by the control module assembly 58 as the control module assembly 58 is installed.

In this example, the control module assembly 58 includes pockets 62 that each slidably receive the portion of the busbar 54 when the control module assembly 58 is moved into an electrically coupled position with the busbars 54. Disposed within each of the pockets 62 are one or more terminal tabs 66 of the control module assembly 58. As the pockets 62 receive the busbars 54, the terminal tabs 66 flex and directly contact the busbars 54 to electrically couple the busbars 54 to the terminal tabs 66 in the remaining portions of the control module assembly 58. The contact between the terminal tabs 66 and the busbars 54 transitions the control module assembly 58 from an electrically decoupled position with the busbars 54 to an electrically coupled position with the busbars 54.

In this example, the control module assembly 58 is a Bussed Electrical Center (BEC) 68 that includes an installation tray 70 and a control portion 74. The BEC 68 can manage the distribution of electrical power between the battery pack 14 and the vehicle 10.

During installation the tray 70 can be moved vertically downward to receive the busbars 54 within the pockets 62. During installation, the tray 70 slides relative to the busbars 54 until the busbars 54 are fully received within the pocket 62 and contacting the terminal tabs 66. The tray 70 can then be connected to the array 30A via a plurality of mechanical fasteners 78.

The control portion 74 is then moved vertically downward to engage the tray 70. The control portion 74 can connect to the tray 70 with snap fit connections, mechanical fasteners, etc. Locating features can be incorporated into the tray 70, the control portion 74, or both to help locate the control portion 74 to the tray 70 during installation.

The busbars 54 are, in this example, electrically connecting a header of the battery array 30A to the control module assembly 58—here the control portion 74. Busbars could electrically connect other components of the traction battery pack 14 in other examples.

Features of the disclosed examples include a system and method of electrically connecting a control module of a battery pack to busbars of the battery pack by moving the control module relative to the busbars in a single direction. This can simplify assembly and shield an operator from contact with the busbars.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack system, comprising:
one or more busbars protruding from a battery array of a traction battery pack; and
a control module assembly that slidably receives the one or more busbars to electrically couple the control module assembly to the one or more busbars.

2. The traction battery pack system of claim 1, wherein the one or more busbars protrude vertically upward from the battery array.

3. The traction battery pack system of claim 1, wherein the control module assembly is secured relative to the battery array at a position vertically above the battery array when the one or more busbars are received by the control module assembly.

4. The traction battery pack system of claim 1, wherein the control module is configured to transition from an electrically decoupled position with the one or more busbars to an electrically decoupled position with the one or more busbars by moving the control module assembly in a single direction relative to the battery array.

5. The traction battery pack system of claim 1, wherein the control module assembly includes one or more pockets, the one or more busbars each received within a respective pocket of the one or more pockets when the control module assembly is electrically coupled to the one or more busbars.

6. The traction battery pack system of claim 5, further comprising at least one terminal tab disposed within the one or more pockets, the at least one terminal tab contacting the one or more busbars when the control module assembly is electrically coupled to the one or more busbars.

7. The traction battery pack system of claim 1, wherein the control module assembly comprises a bussed electrical center and a tray, the tray secured directly to the battery array.

8. The traction battery pack system of claim 7, wherein the bussed electrical center is configured to manage distribution of electrical power between the traction battery pack and a vehicle.

9. The traction battery pack system of claim 1, wherein the one or more busbars are one or more first busbar, wherein the battery array is a first battery array, and further comprising at least one second battery array having one or more second busbars that protrude from the at least one second battery array, the control module assembly configured to slidably receive the one or more second busbars to electrically coupled the control module assembly to the one or more second busbars.

10. The traction battery pack system of claim 1, wherein the one or more busbars each include a protruding portion that protrudes from the battery array and is received by the control module assembly when the control module assembly slidably receives the one or more busbars.

11. A battery module assembly of a traction battery pack, comprising:
a control module of a traction battery pack, the control module configured to slide linearly relative to one or more busbars of a battery array from a first position where the control module is electrically decoupled from the battery array to a second position where the control module is electrically coupled to the one or more busbar of the battery array.

12. The battery module assembly of claim 11, wherein the control module is a bussed electrical center.

13. The battery module assembly of claim 11, wherein the control module moves vertically downward from the first position to the second position.

14. The battery module assembly of claim 11, wherein the control module includes one or more pockets that each respectively receive a portion of the one or more busbars when the control module is electrically coupled to the battery array.

15. A traction battery pack electrical connection method, comprising:
transitioning a control module along an axis from a first position to a second position relative to a battery array, the control module electrically decoupled from the battery array in the first position, the control module electrically coupled to the battery array in the second position; and
during the transitioning, receiving portions of a plurality of busbars within respective pockets of the control module.

16. The method of claim 15, wherein the busbars within the plurality of busbars extend vertically upward from the battery array.

17. The method of claim 15, further comprising, when the portions of the plurality of busbars are received within the respective pockets, contacting the plurality of busbars against terminal tabs disposed within the respective pockets to electrically coupled the control module to the battery array.

18. The method of claim 15, wherein the transitioning is a vertically downward transitioning of the control module.

19. The method of claim 15, wherein the control module is a bussed electrical center is configured to manage a distribution of electrical power between the battery pack and a vehicle.
